(19) United States
(12) Patent Application Publication
(10) Pub. No.: US 2026/0062572 A1
(43) Pub. Date: Mar. 5, 2026

(54) Water-Based Adhesive Composition For Textile Printing, Transport Belt, And Textile Printing Apparatus

(71) Applicant: SEIKO EPSON CORPORATION, Tokyo (JP)

(72) Inventors: Harunobu KOMATSU, Matsumoto (JP); Nikako TSUKIJI, Matsumoto (JP); Soichi YAMAZAKI, Shiojiri (JP); Koichi TERAO, Suwa (JP); Kenji KITADA, Shiojiri (JP)

(21) Appl. No.: 19/314,088

(22) Filed: Aug. 29, 2025

(30) Foreign Application Priority Data
Aug. 30, 2024 (JP) 2024-148496

(51) Int. Cl. C09D 11/30; B41J 3/407; B41J 15/04

(52) U.S. Cl. CPC C09D 11/30; B41J 3/4078; B41J 15/048

(57) ABSTRACT

A water-based adhesive composition for textile printing of the present disclosure includes water, a (meth)acrylic resin, and a persulfate, in which a content of the persulfate is 100 ppm or more and 2000 ppm or less. A pH of the water-based adhesive composition for textile printing at 23° C. is preferably 7.5 or more and 9.0 or less.

The present application is based on, and claims priority from JP Application Serial Number 2024-148496, filed Aug. 30, 2024, the disclosure of which is hereby incorporated by reference herein in its entirety.

### BACKGROUND

### 1. Technical Field

The present disclosure relates to a water-based adhesive composition for textile printing, a transport belt, and a textile printing apparatus.

### 2. Related Art

In a textile printing method in which an ink composition is applied to a fabric as a recording medium to perform dyeing, an adhesive layer is formed at the surface of a transport belt that transports the fabric, and the surface being in contact with the fabric. As a result, the fabric can be held by being adhered to the transport belt, and the fabric can be stably transported.

A liquid temporary fixation agent containing an adhesive is used for forming such an adhesive layer.

The adhesive layer is required to have a moderate adhesive force that allows the fabric fixed to the transport belt to be suitably attached and detached, water resistance that can withstand water washing, and mechanical strength. Therefore, a temporary fixation agent in which a hydrophobic resin is dissolved in an organic solvent is used.

In the temporary fixation agent containing an organic solvent, since the organic solvent volatilizes when coated on the transport belt or the like, the restriction on the surrounding environment is increased, such as the need for sufficient ventilation. Therefore, a water-based temporary fixation agent in which the organic solvent does not volatilize is required. As such a water-based temporary fixation agent, an agent as described in JP-A-59-53790 is proposed.

However, the temporary fixation agent described above has a problem in that the storage stability is low or the durability of the adhesive layer formed of the temporary fixation agent is low.

### SUMMARY

The present disclosure can be realized in the following application examples.

According to an application example of the present disclosure, there is provided a water-based adhesive composition for textile printing including water, a (meth)acrylic resin, and a persulfate, in which a content of the persulfate is 100 ppm or more and 2000 ppm or less.

According to another application example of the present disclosure, there is provided a transport belt that transports a fabric to be printed by textile printing, the transport belt including an adhesive layer that is formed of the water-based adhesive composition for textile printing according to the application example of the present disclosure on a surface that is in contact with the fabric.

According to still another application example of the present disclosure, there is provided a textile printing apparatus including the transport belt according to the application example of the present disclosure, and an ink jet head that includes a nozzle discharging ink to the fabric transported by the transport belt.

### BRIEF DESCRIPTION OF THE DRAWINGS

FIG. 1 is a schematic configuration diagram of a textile printing apparatus according to an embodiment of the present disclosure.

FIG. 2 is a diagram illustrating a state where a transport device included in the textile printing apparatus illustrated in FIG. 1 performs a leveling step.

FIG. 3 is a flowchart for describing an example of a method of forming an adhesive layer.

FIG. 4 is a table summarizing the composition and the like of water-based adhesive compositions for textile printing of each example and each comparative example.

FIG. 5 is a table summarizing the evaluation results of each example and each comparative example.

### DESCRIPTION OF EMBODIMENTS

Hereinafter, preferred embodiments of the present disclosure will be described in detail.

### 1. Water-Based Adhesive Composition for Textile Printing

First, a water-based adhesive composition for textile printing of the present disclosure will be described.

A water-based adhesive composition for textile printing of the present disclosure is used to form an adhesive layer provided on a surface of a transport belt that transports a fabric to be printed by textile printing, the surface being in contact with the fabric.

The water-based adhesive composition for textile printing of the present disclosure includes water, a (meth)acrylic resin, and a persulfate, in which the content of the persulfate is 100 ppm or more and 2000 ppm or less. With such a configuration, it is possible to make the durability of the adhesive layer formed of the water-based adhesive composition for textile printing excellent while making the storage stability of the water-based adhesive composition for textile printing excellent. In addition, by using water, it is not necessary to use an organic solvent, and it is not necessary to consider problems caused by using the organic solvent, more specifically, the restriction on the surrounding environment due to the volatilization of the organic solvent. In addition, by forming the adhesive layer using such a water-based adhesive composition for textile printing, during printing, the fabric can be stably fixed to the transport belt and the recorded material obtained by printing can be suitably released from the transport belt.

On the other hand, when the above-described conditions are not satisfied, satisfactory results cannot be obtained.

For example, when the water-based adhesive composition for textile printing does not contain water but contains an organic solvent instead of the water, the effect of using water as described above cannot be obtained. In addition, when the water-based adhesive composition for textile printing does not contain the persulfate, or even when containing the persulfate, the content thereof is less than the lower limit value, the durability of the adhesive layer formed of the water-based adhesive composition for textile printing is significantly inferior. In addition, when the content of the persulfate in the water-based adhesive composition for textile printing exceeds the upper limit value, the storage stability of the water-based adhesive composition for textile printing is significantly lowered.

A transport belt having an adhesive layer formed of the water-based adhesive composition for textile printing of the present disclosure and a textile printing apparatus having the transport belt will be described in detail below.

### 1-1. Water

The water-based adhesive composition for textile printing contains water.

Water is a component that imparts fluidity to the water-based adhesive composition for textile printing.

In the water-based adhesive composition for textile printing, water functions as a solvent that dissolves a component other than water, such as a (meth)acrylic resin or a persulfate, or as a dispersant that disperses the component.

The content of water in the water-based adhesive composition for textile printing is not particularly limited, but is preferably 30.0% by mass or more and 80.0% by mass or less, and more preferably 35.0% by mass or more and 70.0% by mass or less. As a result, the fluidity and viscosity of the water-based adhesive composition for textile printing can be made more suitable, and the coating property of the water-based adhesive composition for textile printing and the uniformity of the thickness of the adhesive layer formed of the water-based adhesive composition for textile printing can be made more excellent.

### 1-2. (Meth)Acrylic Resin

The water-based adhesive composition for textile printing includes a (meth)acrylic resin.

The (meth)acrylic resin has the function of imparting an adhesive property to the adhesive layer formed of the water-based adhesive composition for textile printing.

In particular, by using a (meth)acrylic resin among various adhesive components, the adhesive force of the adhesive layer can be made more appropriate. In addition, the water resistance and mechanical strength of the adhesive layer can be made more excellent. As a result, for example, it is possible to more suitably prevent the unintentional decrease in the adhesive force when the adhesive layer formed of the water-based adhesive composition for textile printing is brushed using water.

The (meth)acrylic resin is not particularly limited as long as the (meth)acrylic resin is a polymer containing (meth)acrylic monomers such as (meth)acrylic acid and (meth)acrylic acid ester as at least a part of the monomer component. For example, the (meth)acrylic resin may be a single polymer formed by polymerizing one type of (meth)acrylic monomer, or may be a copolymer containing a plurality of types of (meth)acrylic monomers as the monomer component. In addition, the (meth)acrylic resin may be a copolymer containing, as a monomer component, a monomer other than the (meth)acrylic monomer in addition to the (meth)acrylic monomer.

The (meth)acrylic resin constituting the water-based adhesive composition for textile printing of the present disclosure may contain a plurality of different polymers. For example, the (meth)acrylic resin may be obtained by blending a plurality of polymers synthesized under different conditions.

The (meth)acrylic monomer is not particularly limited, and examples thereof include (meth)acrylic monomers having an acidic group, (meth)acrylic monomers having an ester structure, (meth)acrylic monomers having an amide structure, and the like. Examples of (meth)acrylic monomers having an acidic group include acrylic acid, methacrylic acid, and the like. Examples of (meth)acrylic monomers having an ester structure include methyl acrylate, methyl methacrylate, ethyl acrylate, ethyl methacrylate, n-propyl acrylate, n-propyl methacrylate, butyl acrylate, butyl methacrylate, lauryl acrylate, lauryl methacrylate, isoamyl acrylate, isoamyl methacrylate, 2-ethylhexyl acrylate, 2-ethylhexyl methacrylate, cyclohexyl acrylate, cyclohexyl methacrylate, and the like. Examples of (meth)acrylic monomers having an amide structure include acrylamide, methacrylamide, N-isopropyl acrylamide, and the like.

The monomer other than the (meth)acrylic monomer is not particularly limited, and examples thereof include styrene and acrylonitrile.

The (meth)acrylic resin preferably contains a first monomer having a glass transition temperature of −60° C. or lower when used as a homopolymer, as a constituent monomer. As a result, the adhesive force of the adhesive layer formed of the water-based adhesive composition for textile printing can be suitably increased, and the fabric can be stably fixed to the transport belt.

The glass transition temperature of the homopolymer can be measured using a homopolymer having a weight average molecular weight of 100,000 or more and 5,000,000 or less. In such a homopolymer having a weight average molecular weight in the above range, the influence of the molecular weight on the glass transition temperature is sufficiently small to be negligible.

The glass transition temperature of the homopolymer of the first monomer may be −60° C. or lower, is preferably −100° C. or higher and −62° C. or lower, and is more preferably −90° C. or higher and −64° C. or lower. As a result, the above-described effect is more remarkably exhibited.

Examples of the preferred first monomers include 2-ethylhexyl acrylate.

When the (meth)acrylic resin contains the first monomer as a constituent monomer, the proportion of the first monomer in all monomers constituting the (meth)acrylic resin is preferably 20.0% by mass or more and 50.0% by mass or less, more preferably 25.0% by mass or more and 45.0% by mass or less, and even more preferably 30.0% by mass or more and 40.0% by mass or less. As a result, the adhesive force of the adhesive layer formed of the water-based adhesive composition for textile printing can be made more suitable, and during printing, the fabric can be stably fixed to the transport belt, and the recorded material obtained by printing can be more suitably released from the transport belt.

The (meth)acrylic resin preferably contains a second monomer having a glass transition temperature of 40° C. or higher when used as a homopolymer, as a constituent monomer. As a result, the mechanical strength of the adhesive layer formed of the water-based adhesive composition for textile printing can be made more excellent. In addition, the adhesive force of the adhesive layer formed of the water-based adhesive composition for textile printing can be made more suitable, and during printing, the fabric can be sufficiently stably fixed to the transport belt, and the recorded material obtained by printing can be more suitably released from the transport belt.

The glass transition temperature of the homopolymer of the second monomer may be 40° C. or higher, is preferably −45° C. or higher and 150° C. or lower, more preferably 50° C. or higher and 140° C. or lower, and even more preferably 60° C. or higher and 135° C. or lower. As a result, the above-described effect is more remarkably exhibited.

The (meth)acrylic resin may contain a monomer having an acidic functional group as a second monomer. As a result, the storage stability of the water-based adhesive composition for textile printing can be made more excellent.

Examples of the preferred second monomers include acrylic acid, methacrylic acid, methyl methacrylate, ethyl methacrylate, cyclohexyl acrylate, and cyclohexyl methacrylate.

When the (meth)acrylic resin contains the first monomer as a constituent monomer, the proportion of the second monomer in all monomers constituting the (meth)acrylic resin is preferably 20.0% by mass or more and 50.0% by mass or less, more preferably 25.0% by mass or more and 45.0% by mass or less, and even more preferably 30.0% by mass or more and 40.0% by mass or less. As a result, the mechanical strength of the adhesive layer formed of the water-based adhesive composition for textile printing can be made more excellent. In addition, the adhesive force of the adhesive layer formed of the water-based adhesive composition for textile printing can be made more suitable, and during printing, the fabric can be sufficiently stably fixed to the transport belt, and the recorded material obtained by printing can be further suitably released from the transport belt.

When the (meth)acrylic resin contains the first monomer and the second monomer as the constituent monomer, and when the mass ratio of the first monomer in the (meth)acrylic resin is X1 [% by mass] and the mass ratio of the second monomer is X2 [% by mass], it is preferable to be 0.7≤X2/X1≤1.4, more preferable to be 0.8≤X2/X1≤1.3, and even more preferable to be 0.9≤X2/X1≤1.2. As a result, the adhesive force of the adhesive layer formed of the water-based adhesive composition for textile printing can be made more suitable, and during printing, the fabric can be more stably fixed to the transport belt, and the recorded material obtained by printing can be further suitably released from the transport belt. In addition, the mechanical strength of the adhesive layer formed of the water-based adhesive composition for textile printing can be made more excellent.

The (meth)acrylic resin preferably contains, as a constituent monomer, a third monomer having a glass transition temperature of higher than −60° C. and lower than 40° C. when used as a homopolymer, in addition to the first monomer and the second monomer. As a result, the adhesive force of the adhesive layer formed of the water-based adhesive composition for textile printing can be made more suitable, and during printing, the fabric can be stably fixed to the transport belt, and the recorded material obtained by printing can be more suitably released from the transport belt.

The glass transition temperature of the homopolymer of the third monomer may be higher than −60° C. and lower than 40° C., is preferably −58° C. or higher and 30° C. or lower, and more preferably −56° C. or higher and 25° C. or lower. As a result, the above-described effect is more remarkably exhibited.

Examples of the preferred third monomers include butyl acrylate, butyl methacrylate, and isoamyl acrylate.

When the (meth)acrylic resin contains a third monomer as a constituent monomer, the proportion of the third monomer in all monomers constituting the (meth)acrylic resin is preferably 10.0% by mass or more and 40.0% by mass or less, more preferably 15.0% by mass or more and 35.0% by mass or less, and even more preferably 20.0% by mass or more and 30.0% by mass or less. As a result, the adhesive force of the adhesive layer formed of the water-based adhesive composition for textile printing can be made more suitable, and during printing, the fabric can be more stably fixed to the transport belt, and the recorded material obtained by printing can be further suitably released from the transport belt.

When the mass ratio of the first monomer in the (meth)acrylic resin is X1 [% by mass] and the mass ratio of the third monomer is X3 [% by mass], it is preferable to be 0.8≤X1/X3≤1.7, more preferable to be 0.9≤X1/X3≤1.6, and even more preferable to be 1.0≤X1/X3≤1.5. As a result, the above-described effect is more remarkably exhibited.

When the mass ratio of the second monomer in the (meth)acrylic resin is X2 [% by mass] and the mass ratio of the third monomer is X3 [% by mass], it is preferable to be 0.8≤X2/X3≤1.7, more preferable to be 0.9≤X2/X3≤1.6, and even more preferable to be 1.0≤X2/X3≤1.5. As a result, the above-described effect is more remarkably exhibited.

The content of the (meth)acrylic resin in the water-based adhesive composition for textile printing is preferably 20.0% by mass or more and 70.0% by mass or less, and more preferably 30.0% by mass or more and 60.0% by mass or less. As a result, the mechanical strength of the adhesive layer formed of the water-based adhesive composition for textile printing can be made more excellent. In addition, the adhesive force of the adhesive layer formed of the water-based adhesive composition for textile printing can be made more suitable, and during printing, the fabric can be more stably fixed to the transport belt, and the recorded material obtained by printing can be more suitably released from the transport belt. In addition, the coating property and storage stability of the water-based adhesive composition for textile printing can be made more excellent.

### 1-3. Persulfate

The water-based adhesive composition for textile printing contains a predetermined content of the persulfate. More specifically, the content of the persulfate in the water-based adhesive composition for textile printing of the present disclosure may be 100 ppm or more and 2000 ppm or less, but is preferably 120 ppm or more and 1500 ppm or less, more preferably 130 ppm or more and 1200 ppm or less, and even more preferably 150 ppm or more and 1000 ppm or less. As a result, the above-described effect is more remarkably exhibited.

Examples of the persulfates include alkali metal salts such as sodium persulfate, potassium persulfate, sodium hydrogen persulfate, and potassium hydrogen persulfate, alkaline earth metal salts such as magnesium persulfate and calcium persulfate, and ammonium salts such as ammonium persulfate, and it is preferable to contain ammonium persulfate. As a result, the durability of the adhesive layer formed of the water-based adhesive composition for textile printing can be more stably maintained. In addition, the storage stability of the water-based adhesive composition for textile printing can be made more excellent.

The persulfate contained in the water-based adhesive composition for textile printing may be a residue of the persulfate used as a thermal polymerization initiator during the synthesis of the above-described (meth)acrylic resin. In addition, the content of the persulfate in the water-based adhesive composition for textile printing can be adjusted, for example, by the amount of thermal polymerization initiator used in the synthesis of the (meth)acrylic resin, the reaction time and reaction temperature in the synthesis reaction of the (meth)acrylic resin, and the like.

### 1-4. Monomer

The water-based adhesive composition for textile printing may contain a monomer that is the same type as the monomer constituting the (meth)acrylic resin described above, and is in an unpolymerized state at the content of 1000 ppm or less. As a result, the safety of the water-based adhesive composition for textile printing can be further improved. In addition, since the monomer in an unpolymerized state is not extremely reduced (less than 10 ppm or the like), the amount of the used persulfate can be reduced.

The content of the monomer in the water-based adhesive composition for textile printing is preferably 1000 ppm or less, more preferably 10 ppm or more and 800 ppm or less, and even more preferably 100 ppm or more and 500 ppm or less. As a result, the above-described effect is more remarkably exhibited, the (meth)acrylic resin can be easily synthesized, and it is not necessary to excessively purify the (meth)acrylic resin after the synthesis, and the like, which is advantageous in terms of productivity and cost of the water-based adhesive composition for textile printing.

### 1-5. Alcohol Compound

When the above-described (meth)acrylic resin contains the ester compound of (meth)acrylic acid represented by the following Formula (1) as a constituent monomer, the water-based adhesive composition for textile printing may further contain the alcohol compound represented by the following Formula (2) at the content of 1000 ppm or less.

$${R}^{1} - C ( = C {H}_{2} ) - C ( = O ) - O - {R}^{2} \qquad ( 1 )$$

(In Formula (1), R¹ is H or CH₃, and R² is a hydrocarbon group.)

$${R}^{2} - OH \qquad ( 2 )$$

(In Formula (2), R² is a hydrocarbon group.)

As a result, the durability of the adhesive layer formed of the water-based adhesive composition for textile printing can be made more excellent. This is because it is possible to prevent the reduction of the persulfate by extending the reaction time, and thus it is possible to reduce the alcohol compound obtained by the hydrolysis of the ester compound of (meth)acrylic acid.

The content of the alcohol compound in the water-based adhesive composition for textile printing is preferably 1000 ppm or less, more preferably 10 ppm or more and 900 ppm or less, and even more preferably 100 ppm or more and 700 ppm or less. As a result, the above-described effect is more remarkably exhibited, the (meth)acrylic resin can be easily synthesized, and it is not necessary to excessively purify the (meth)acrylic resin after the synthesis, and the like, which is advantageous in terms of productivity and cost of the water-based adhesive composition for textile printing.

The alcohol compound depends on the type of ester compound of (meth)acrylic acid as a constituent monomer of the (meth)acrylic resin. For example, when the (meth)acrylic resin contains methyl acrylate or methyl methacrylate as a constituent monomer, the alcohol compound is methanol. In addition, when the (meth)acrylic resin contains ethyl acrylate or ethyl methacrylate as a constituent monomer, the alcohol compound is ethanol. In addition, when the (meth)acrylic resin contains n-propyl acrylate or n-propyl methacrylate as a constituent monomer, the alcohol compound is n-propanol. In addition, when the (meth)acrylic resin contains butyl acrylate or butyl methacrylate as a constituent monomer, the alcohol compound is butanol.

### 1-6. Preservative

The water-based adhesive composition for textile printing may contain a preservative. As a result, it is possible to effectively prevent the occurrence of corruption by microorganisms in the water-based adhesive composition for textile printing or the adhesive layer formed of the water-based adhesive composition for textile printing.

The preservative may be an inorganic preservative, and is preferably an organic preservative. As a result, the storage stability of the water-based adhesive composition for textile printing can be made more excellent.

Examples of the inorganic preservatives include an agent on which silver, zinc, copper, or the like having an antibacterial property is carried, using zeolite, silica gel, potassium titanate whisker, magnesium oxide whisker, or the like as a carrier.

Examples of the organic preservatives include a thiazoline-based antibacterial agent, an imidazole-based antibacterial agent, an ester-based antibacterial agent, a carboxylic acid-based antibacterial agent, and the like.

Examples of the thiazoline-based antibacterial agents include 2-n-octyl-4-isothiazolone-3-one, 1,2-benzisothiazol-3(2H)-one, methylisothiazolinone, 5-chloro-2-methyl-4-isothiazolin-3-one, and the like.

Examples of the imidazole-based antibacterial agents include 2-(4-thiazolyl)-benzimidazole, methyl-2-benzimidazole carbamate, and the like.

Examples of the ester-based antibacterial agents include glycerol monolaurate and the like.

Examples of the carboxylic acid-based antibacterial agents include sorbic acid, salts thereof, and the like. Examples of the salts include potassium salts and the like.

Among these, as the preservative, a thiazoline-based antibacterial agent is preferable, and 1,2-benzisothiazol-3(2H)-one is more preferable. As a result, the affinity with the above-described (meth)acrylic resin (in particular, the (meth)acrylic resin containing the preferable first monomer, the second monomer, and the third monomer as a constituent monomer) can be made more excellent. As a result, the preservative can be more uniformly dispersed in the adhesive layer, and the mechanical strength, water resistance, antiseptic properties, and the like of the adhesive layer can be made more excellent.

When the water-based adhesive composition for textile printing contains a preservative, the content of the preservative in the water-based adhesive composition for textile printing is not particularly limited, but is preferably 0.001% by mass or more and 0.10% by mass or less, more preferably 0.01% by mass or more and 0.05% by mass or less, and even more preferably 0.02% by mass or more and 0.04% by mass or less. As a result, the above-described effect of containing the preservative is more remarkably exhibited, and the adhesive property, durability, and the like of the adhesive layer formed of the water-based adhesive composition for textile printing can be made more suitable.

### 1-7. Surfactant

The water-based adhesive composition for textile printing may contain a surfactant.

The surfactant is not particularly limited, and examples thereof include an anionic surfactant, a nonionic surfactant, and a cationic surfactant.

Examples of the anionic surfactants include alkyl sulfates such as alkyl sulfocarboxylate, alkyl diphenyl ether disulfonate, α-olefin sulfonate, polyoxyethylene alkyl ether acetate, N-acylamino acid, and a salt thereof, an N-acylmethyl taurine salt, ammonium lauryl sulfate, or sodium lauryl sulfate, alkyl sulfate polyoxyalkyl ether sulfate, alkyl sulfate polyoxyethylene alkyl ether phosphate, rosin acid soap, castor oil sulfate ester, lauryl alcohol sulfate ester, alkylphenol type phosphate ester, alkyl type phosphate ester, alkylaryl sulfonate, diethyl sulfosuccinate, diethyl hexyl sulfosuccinate, dioctyl sulfosuccinate, and the like.

Examples of the nonionic surfactants include an acetylene glycol-based surfactant, a silicone-based surfactant, polyoxyethylene alkyl ether, polyoxyethylene alkyl phenyl ether, polyoxyethylene fatty acid ester, polyoxyethylene hardened castor oil, propylene glycol fatty acid ester, glycerin fatty acid ester, polyglycerin fatty acid ester, sorbitan fatty acid ester, sucrose fatty acid ester, alkyl polyglycoside, alkyl diethanolamide, alkyl amine oxide, and the like. Examples of commercially available nonionic surfactants include Emulgen 123P, 430, 1108 (product names manufactured by Kao Corporation), Newcol 1006, 1008, 1020 (product names manufactured by Nihon Emulsion Co., Ltd.), Noigen DL-0415, ET-116B, ET-106A, DH-0300, YX-400, EA-160 (product names manufactured by Daiichi Kogyo Seiyaku Co., Ltd.), and the like.

Examples of the cationic surfactants include alkylamine salts, fatty acid amidoamine salts, monoalkyl quaternary ammonium salts, dialkyl quaternary ammonium salts, trialkyl quaternary ammonium salts, benzalkonium quaternary ammonium salts, benzetonium chloride, alkylpyridinium salts, and the like.

Among these, an anionic surfactant is preferable, and an alkyl ether-based nonionic surfactant is more preferable. As a result, the final emulsion is more stabilized.

The content of the surfactant in the water-based adhesive composition for textile printing is preferably 1.0% by mass or more and 5.0% by mass or less, and more preferably 1.5% by mass or more and 5.0% by mass or less.

### 1-8. Adhesive Imparting Agent

The water-based adhesive composition for textile printing may contain an adhesive imparting agent.

Examples of the adhesive imparting agents include a rosin-based compound, a terpene-based compound, a hydrocarbon resin, and the like. More specific examples of the adhesive imparting agents include: a rosin-based compound such as natural rosin, a modified rosin, a glycerol ester of natural rosin, a glycerol ester of modified rosin, a pentaerythritol ester of natural rosin, or a pentaerythritol ester of modified rosin; a terpene-based compound such as a copolymer of natural terpene, a three-dimensional polymer of natural terpene, an aromatic modified terpene resin, a hydrogenated derivative of an aromatic modified terpene resin, a terpene phenol resin, or a terpene resin (monoterpene, diterpene, triterpene, polyterpene, and the like); and a hydrocarbon resin such as an aliphatic petroleum hydrocarbon resin (C5 resin), a hydrogenated derivative of the aliphatic petroleum hydrocarbon resin, an aromatic petroleum hydrocarbon resin (C9 resin) such as a styrene oligomer, or a hydrogenated derivative of the aromatic petroleum hydrocarbon resin, and the like.

When the water-based adhesive composition for textile printing contains the adhesive imparting agent, the content of the adhesive imparting agent in the water-based adhesive composition for textile printing is not particularly limited, but is preferably 5.0% by mass or less, more preferably 4.0% by mass or less, and even more preferably 0.1% by mass or more and 3.8% by mass or less. As a result, the adhesive force of the adhesive layer formed of the water-based adhesive composition for textile printing is made more suitable, and the effect of preventing the decrease in adhesive force when the adhesive layer is brushed is likely to be sustained for a longer period.

### 1-9. Coloring Material

The water-based adhesive composition for textile printing may contain a coloring material.

As the coloring material, for example, various pigments and various dyes can be used.

When the water-based adhesive composition for textile printing contains a coloring material, the content of the coloring material in the water-based adhesive composition for textile printing is preferably 1.0% by mass or less, and more preferably 0.5% by mass or less.

### 1-10. Other Components

The water-based adhesive composition for textile printing may contain components other than the above components. Hereinafter, such a component will also be referred to as “other components”.

Examples of other components include resin materials other than (meth)acrylic resins, antioxidants, coloring agents, antistatic agents, flame retardants, flame retardant aids, ultraviolet absorbers, aggregation inhibitors, processing aids, plasticizers, defoamers, and the like.

Examples of the resin materials other than (meth)acrylic resin include urethane resin, silicone resin, various elastomers (rubber-based materials), and the like.

However, the content of the other components in the water-based adhesive composition for textile printing is preferably 10.0% by mass or less, more preferably 5.0% by mass or less, and even more preferably 3.0% by mass or less.

In particular, the water-based adhesive composition for textile printing preferably does not contain an organic solvent or contains a small amount of the organic solvent from the viewpoint of reducing the environmental load and the restriction on the surrounding environment due to the volatilization of the organic solvent. More specifically, the content of the organic solvent in the water-based adhesive composition for textile printing is preferably 5.0% by mass or less, more preferably 2.5% by mass or less, and even more preferably 0.5% by mass or less.

### 1-11. Other Conditions

The water-based adhesive composition for textile printing preferably contains an ammonium ion. As a result, the pH of the water-based adhesive composition for textile printing can be made relatively high, and in particular, the water-based adhesive composition for textile printing can be suitably maintained in an alkaline state. As a result, hydrolysis of the (meth)acrylic resin can be more effectively prevented, and the durability of the adhesive layer formed of the water-based adhesive composition for textile printing can be more stably maintained. In addition, the storage stability of the water-based adhesive composition for textile printing can be made more excellent.

The pH of the water-based adhesive composition for textile printing at 23° C. is preferably 7.5 or more and 9.0 or less, more preferably 7.7 or more and 8.8 or less, and even more preferably 7.9 or more and 8.6 or less. As a result, the hydrolysis of the (meth)acrylic resin can be more effectively prevented, and the durability of the adhesive layer formed of the water-based adhesive composition for textile printing can be more stably maintained. In addition, the storage stability of the water-based adhesive composition for textile printing can be made more excellent.

The viscosity of the water-based adhesive composition for textile printing at 23° C. is not particularly limited, and is preferably 10 mPa·s or more and 300 mPa·s or less, and more preferably 10 mPa·s or more and 300 mPa·s or less. As a result, the handling property when coating the water-based adhesive composition for textile printing is more excellent, and it is possible to more suitably prevent the unintended variation in the thickness and the surface property of the formed adhesive layer.

The storage elastic modulus of the adhesive layer formed of the water-based adhesive composition for textile printing at 23° C. is preferably 1.5×10⁵ Pa or more and 5.0×10⁵ Pa or less, more preferably 1.6×10⁵ Pa or more and 4.8×10⁵ Pa or less, and even more preferably 2.0×10⁵ Pa or more and 4.5×10⁵ Pa or less.

A method of forming the adhesive layer for measuring the storage elastic modulus is not particularly limited, and for example, a method of coating a water-based adhesive composition for textile printing to a 25 mm wide slide glass to have a thickness of 0.2 mm under an environment of 23° C. and drying under conditions of humidity of 50%, 23° C., and 8 hours can be adopted.

### 2. Textile Printing Apparatus and Transport Belt

Next, a transport belt and a textile printing apparatus according to the present disclosure will be described.

The transport belt of the present disclosure is a transport belt that transports a fabric to be printed by textile printing, and includes an adhesive layer formed of the water-based adhesive composition for textile printing of the present disclosure on a surface that is in contact with the fabric. As a result, the durability of the adhesive layer can be made excellent. In addition, during printing, the fabric can be stably fixed to the transport belt, and the recorded material obtained by printing can be suitably released from the transport belt. In addition, since the adhesive layer can be formed of a water-based adhesive composition for textile printing containing water, it is not necessary to use an organic solvent in the water-based adhesive composition for textile printing, and it is not necessary to consider problems caused by using an organic solvent, more specifically, the restriction on the surrounding environment due to the volatilization of the organic solvent, environmental loads, and the like.

The textile printing apparatus of the present disclosure includes the transport belt of the present disclosure, and an ink jet head that includes a nozzle discharging ink to the fabric transported by the transport belt. As a result, the durability of the adhesive layer can be made excellent. In addition, during printing, the fabric can be stably fixed to the transport belt, and the recorded material obtained by printing can be suitably released from the transport belt. In addition, since the adhesive layer can be formed of a water-based adhesive composition for textile printing containing water, it is not necessary to use an organic solvent in the water-based adhesive composition for textile printing, and it is not necessary to consider problems caused by using an organic solvent, more specifically, the restriction on the surrounding environment due to the volatilization of the organic solvent, environmental loads, and the like.

Hereinafter, the transport belt and the textile printing apparatus of the present disclosure will be described in more detail with reference to the drawings.

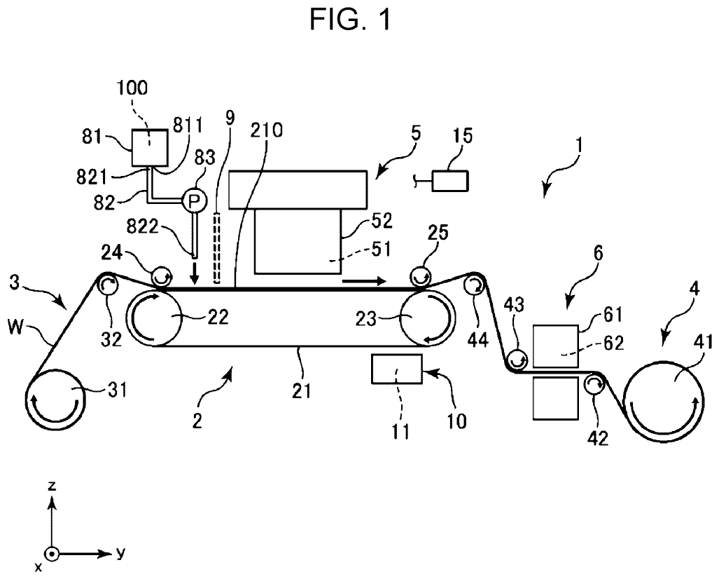

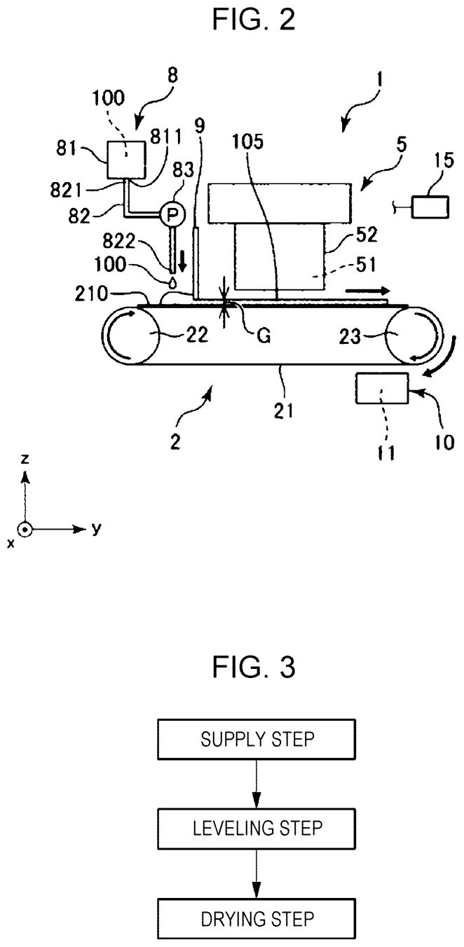

FIG. 1 is a schematic configuration diagram of a textile printing apparatus according to an embodiment of the present disclosure. FIG. 2 is a diagram illustrating a state where a transport device included in the textile printing apparatus illustrated in FIG. 1 performs a leveling step. FIG. 3 is a flowchart for describing an example of a method of forming an adhesive layer.

In the following, for convenience of description, FIGS. 1 and 2 illustrate an x-axis, a y-axis, and a z-axis as three axes orthogonal to each other. The x-axis is an axis along one direction (width direction of the transport belt) in the horizontal direction, the y-axis is an axis along a direction (traveling direction of the transport belt) in the horizontal direction perpendicular to the x-axis, and the z-axis is an axis along a direction (up and down direction in the drawing) in the vertical direction. In addition, the tip end side of each arrow illustrated in the drawing is referred to as a “positive side (+ side)”, and the base end side is referred to as a “negative side (− side)”. In addition, the upper sides of FIGS. 1 and 2 are referred to as “upper” or “upward”, and a lower side is referred to as “lower” or “downward”.

As illustrated in FIGS. 1 and 2, a textile printing apparatus 1 includes a transport device 2 having a transport belt 21 that transports a fabric W, a feeding device 3 that feeds a long fabric W wound in a roll shape, a winding device 4 that winds a printed fabric W, a printing portion 5 that applies ink to the fabric W transported by the transport belt 21 to perform printing, and an ink drying portion 6 that dries the ink on the fabric W.

In the present embodiment, a direction orthogonal to the transport direction in which the fabric W is transported is an x-axis direction, a direction parallel to the transport direction is a y-axis direction, and a direction orthogonal to the x-axis direction and the y-axis direction is a z-axis direction.

As the fabric W, a woven fabric, a knitted fabric, a nonwoven fabric, or the like of natural fibers such as cotton, silk, and wool, or chemical fibers such as nylon, or a composite fiber obtained by mixing these can be used. The fabric W may be clothing, other clothing products, or the like. The clothing and other clothing products include, for example, sewn T-shirts, handkerchiefs, scarves, towels, shopping bags, cloth bags, furniture such as curtains, sheets, and bed covers, as well as fabrics before and after cutting existing as a part in a state before sewing.

The transport device 2 includes a drive roller 22 and a driven roller 23 disposed to be separated from each other in the y-axis direction, a transport belt 21 that is hung on the drive roller 22 and the driven roller 23 and supports the fabric W on an upper surface (supporting surface), and tensioners 24 and 25 that apply tension to the fabric W between the drive roller 22 and the driven roller 23.

A motor (not illustrated) is coupled to the drive roller 22, and the drive roller 22 can be rotationally driven by the operation of the motor. In addition, the rotating force of the drive roller 22 is transmitted to the driven roller 23 via the transport belt 21, and the driven roller 23 can be rotated in conjunction with the drive roller 22.

The transport belt 21 is an endless belt in which an adhesive layer having an adhesive property is formed at the surface on the front side. A part of the fabric W is adhesively fixed to the adhesive layer, and the fabric W is transported to the + side in the y-axis direction. Desired printing is performed on the fabric W during this transport. After printing is performed, the fabric W is released from the transport belt 21. As illustrated in FIG. 2, the adhesive layer is formed by supplying a coating liquid 100 from a coating liquid supply portion 8. The surface of the transport belt 21 in contact with the fabric W is a coating surface 210 on which the coating liquid 100 is coated. The water-based adhesive composition for textile printing of the present disclosure described above is used as the coating liquid 100.

The tensioners 24 and 25 are also disposed to be separated from each other in the y-axis direction, similar to the drive roller 22 and the driven roller 23.

The tensioner 24 can pinch the fabric W between the transport belt 21 and the drive roller 22, and the tensioner 25 can pinch the fabric W between the transport belt 21 and the driven roller 23. As a result, the fabric W to which an appropriate tension is applied by the tensioners 24 and 25 is adhesively fixed to the transport belt 21 in a state where the tension is applied, and is transported. In such a state, the occurrence of wrinkles, sagging, and the like during transportation of the fabric W is reduced, and thus, when printing is performed, the printing can be performed appropriately and with high quality.

As illustrated in FIG. 1, the feeding device 3 is disposed upstream in the feeding direction of the fabric W from the transport device 2, that is, on the − side in the y-axis direction. The feeding device 3 includes a feeding roller (feeding reel) 31 around which the fabric W is wound in a roll shape and that feeds the fabric W, and a tensioner 32 that applies tension to the fabric W between the feeding roller 31 and the transport device 2. A motor (not illustrated) is coupled to the feeding roller 31, and the feeding roller 31 can be rotationally driven by the operation of the motor.

The winding device 4 is disposed downstream the driven roller 23 in the feeding direction of the fabric W, that is, on the + side in the y-axis direction with respect to the transport device 2. The winding device 4 includes a winding roller 41 that winds the fabric W into a roll shape, and tensioners 42, 43, and 44 that apply tension to the fabric W between the winding roller 41 and the transport device 2. A motor (not illustrated) is coupled to the winding roller 41, and the winding roller 41 can be rotationally driven by the operation of the motor. Each of the tensioners 42, 43, and 44 is disposed in this order at intervals in a direction away from the winding roller 41.

The printing portion 5 includes a carriage unit 52 having a plurality of ink jet heads 51 that discharge ink toward the fabric W to perform recording by printing, and an X-axis table (not illustrated) that movably supports the carriage unit 52 in the x-axis direction. Each of the ink jet heads 51 has, for example, a head main body in which an internal flow path filled with ink is formed and a large number of nozzle groups having openings.

The head main body is provided with a piezoelectric element (piezoelectric body) corresponding to each discharge nozzle, and when a voltage is applied to the piezoelectric element, ink is discharged from the nozzle group as droplets.

In a state where the ink jet head 51 does not discharge the ink, the ink jet head 51 stands by at a standby position, which is a position deviated from the fabric W (transport belt 21) in the x-axis direction when viewed from the z-axis direction.

In the textile printing apparatus 1, the fabric W fed by the feeding device 3 is intermittently fed to the + side in the y-axis direction in a fixed state where the fabric W is adhesively fixed by the transport belt 21, and the ink is discharged from the nozzle group while the carriage unit 52 reciprocates in the x-axis direction with respect to the fabric W in the fixed state. As a result, a desired image pattern is formed at the fabric W, and printing is performed. The image pattern may be obtained by multi-color printing or may be obtained by monochrome printing.

The inks include, for example, four colors of cyan (C), magenta (M), yellow (Y), and black (K) containing a dye or a pigment as a coloring agent in water as a solvent. Each ink of each color is independently discharged from the ink jet head 51.

As illustrated in FIG. 1, the ink drying portion 6 is disposed downstream the printing portion 5 in the transport direction of the fabric W, that is, on the + side in the y-axis direction, between the transport device 2 and the winding roller 41 of the winding device 4.

The ink drying portion 6 includes a chamber 61 and a coil 62 which is a heat source (heater) disposed in the chamber 61. The coil 62 is made of, for example, a nichrome wire, and is made of a heating element that generates heat by supplying electric power. The heat emitted by the coil 62 can dry the ink on the fabric W passing through the chamber 61.

The textile printing apparatus 1 includes a control portion 15 that controls the operation of each section of the textile printing apparatus 1 or the transport device 2. That is, the control portion 15 controls the drive roller 22, the feeding roller 31, the winding roller 41, the ink jet head 51, the carriage unit 52, the coil 62, a liquid feeding pump 83, the coil 11, and the like to be driven at a desired timing and under desired conditions, respectively. More specifically, each of the motor of the drive roller 22, the motor of the feeding roller 31, the motor of the winding roller 41, the ink jet head 51, the carriage unit 52, the coil 62, the liquid feeding pump 83, and the coil 11 is electrically coupled to a power supply portion (not illustrated), and the control portion 15 controls the power supply conditions from the power supply portion to each of these sections to drive each of these sections at a desired timing and under desired conditions (speed, temperature, and the like).

The control portion 15 is configured with a semiconductor integrated circuit, and includes a calculation processing portion, a control signal transmission/reception portion, and a storage portion. The storage portion stores a program for executing the operation of each of the above sections, information on the operation condition, and the like.

In such a textile printing apparatus 1, when the printing on the fabric W is not performed, the water-based coating liquid 100 is regularly supplied onto the transport belt 21 to form the adhesive layer. That is, in the textile printing apparatus 1, the coating liquid supply portion 8, a blade 9, and an adhesive drying portion 10 included in the transport device 2 operate as described later, so that a coating film 105 of the coating liquid 100 on the surface (coating surface 210) of the transport belt 21 on the side of the fabric W, and the adhesive layer obtained by drying the coating film 105 are formed.

Next, a transport device 2 will be described.

As illustrated in FIGS. 1 and 2, the transport device 2 includes the transport belt 21, the coating liquid supply portion 8 that supplies the coating liquid 100 to the coating surface 210 on a fabric W side of the transport belt 21, the blade 9 that levels the coating liquid 100 supplied to the coating surface 210, and the adhesive drying portion 10 that dries the coating film 105 obtained by passing through the blade 9. Each of the coating liquid supply portion 8, the blade 9, and the adhesive drying portion 10 may be incorporated in the transport device 2, or may be configured to be attachable and detachable.

The coating liquid supply portion 8 includes a storage portion 81 that stores the coating liquid 100, a liquid feeding pipe 82 that feeds the coating liquid 100 in the storage portion 81 to the vicinity of the coating surface 210, and the liquid feeding pump 83 provided in the middle of a liquid feeding pipe 82, and performs a supply step illustrated in FIG. 3 by these components.

The storage portion 81 used in the supply step is configured to include a hard or flexible container that can store the coating liquid 100. By operating the liquid feeding pump 83, the coating liquid 100 in the storage portion 81 is discharged from a discharge port 811, fed via the liquid feeding pipe 82, discharged from the other end portion 822 of the liquid feeding pipe 82 toward the coating surface 210, and supplied.

In the present embodiment, when the coating liquid supply portion 8 supplies the coating liquid 100, the transport belt 21 is continuously rotationally driven to travel. In this case, the traveling speed of the transport belt 21 is set to be constant. As a result, a portion to be supplied on the coating surface 210 can be continuously changed while the coating liquid 100 is supplied. In addition, the coating liquid 100 can be continuously leveled in a leveling step described later.

The traveling speed of the transport belt 21 in the supply step and the leveling step described later, that is, when the coating liquid 100 is supplied and leveled, is not particularly limited, but is preferably 4 mm/second or more and 67 mm/second or less, and more preferably 8 mm/second or more and 33 mm/second or less. By setting the traveling speed as described above, the coating of the coating liquid 100 can be performed quickly, and a more uniform and good coating film 105 can be obtained.

In the present disclosure, the transport belt 21 may be intermittently rotationally driven. Furthermore, the transport belt 21 may be configured to be rotationally driven at any timing and at any speed.

The storage portion 81 has a discharge port 811 for discharging the coating liquid 100 stored inside. One end portion 821 of the liquid feeding pipe 82 is coupled to the discharge port 811. The liquid feeding pipe 82 transfers the coating liquid 100 in the vicinity of the coating surface 210. The other end portion 822 of the liquid feeding pipe 82 is positioned above the coating surface 210 of the transport belt 21 and upstream the printing portion 5 (− side in the y-axis direction). Therefore, the coating liquid 100 discharged from the other end portion 822 of the liquid feeding pipe 82 is dropped or ejected at a position biased to the − side in the y-axis direction, that is, a position biased to the drive roller 22 side, in the coating surface 210 of the transport belt 21.

Although not illustrated, the other end portion 822 of the liquid feeding pipe 82 is branched into a plurality of pieces. The branch flow paths on the branched tip are disposed side by side along the x-axis direction, that is, along the width direction of the transport belt 21. As a result, the coating liquid 100 can be supplied uniformly and evenly (without excess or deficiency) to a required region of the coating surface 210.

A nozzle, an orifice, or the like may be provided at the other end portion 822 of the liquid feeding pipe 82.

As described above, the transport device 2 includes the liquid feeding pipe 82 coupled to the discharge port 811 and transferring the coating liquid 100 to the coating surface 210. As a result, the degree of freedom of the installation position of the storage portion 81 can be increased. The liquid feeding pipe 82 may be omitted, and the liquid may be directly supplied from the discharge port 811 to the coating surface 210 of the transport belt 21. In this case, the discharge port 811 is installed in a state facing downward.

A supply amount per unit time of the coating liquid 100 supplied onto the coating surface 210 from the liquid feeding pipe 82, that is, a sum of the supply amounts of each branch flow path (hereinafter, simply referred to as a “supply amount”) is not particularly limited, but is preferably 15 mL/min or more and 67 mL/min or less, and more preferably 15 mL/min or more and 35 mL/min or less. By setting the supply amount in this manner, the coating liquid 100 can be quickly coated, and the leveling in the leveling step described later can be performed more uniformly and satisfactorily.

The coating liquid supply portion 8 may be configured to continuously supply the coating liquid 100, or may be configured to intermittently supply the coating liquid 100.

In the present embodiment, the configuration is adopted in which the coating liquid 100 is supplied by the operation of the liquid feeding pump 83 provided in the liquid feeding pipe 82, but the present disclosure is not limited thereto.

For example, the storage portion 81 may be configured to include a flexible container, and may have a pressurizing portion that pressurizes the storage portion 81 from the outside. The pressurizing portion may pressurize the storage portion 81 to push out the coating liquid 100 in the storage portion 81 from the discharge port 811. The coating liquid 100 may be fed through the liquid feeding pipe 82, and discharged from the other end portion 822 to supply the coating liquid 100 to the coating surface 210. In this case, examples of the pressurizing portions include a pressurizing portion to pressurize the storage portion 81 by air pressure, a pressurizing portion to physically pressurize the storage portion 81 by a member such as a pressurizing plate or a pressurizing roller, and the like.

In addition, as another configuration, the coating liquid 100 in the storage portion 81 may be supplied to the coating surface 210 by free falling via the liquid feeding pipe 82.

The blade 9 levels the coating liquid 100 supplied to the coating surface 210 of the traveling transport belt 21 to a uniform thickness. The coating liquid 100 applied inside the coating surface 210 is uniformly leveled by the blade 9, which is the leveling step illustrated in FIG. 3.

In the present embodiment, a coating step of coating the coating liquid 100 on the coating surface 210 includes the supply step and the leveling step.

The blade 9 used in the leveling step has an elongated shape extending in the width direction of the transport belt 21. The blade 9 is fixed in a suspended state above the transport belt 21 by a support portion (not illustrated).

The blade 9 is provided between the other end portion 822 of the liquid feeding pipe 82 and the printing portion 5, that is, downstream (+ side in y-axis direction) the other end portion 822 of the liquid feeding pipe 82.

The lower end of the blade 9, that is, the end portion on the − side in the z-axis direction is provided to be separated from the coating surface 210 by a predetermined distance G. The distance G is an important factor in determining the thickness of the coating liquid 100, that is, the coating film 105 after the leveling step, and is particularly an important factor in determining the film thickness of the obtained adhesive layer. The distance G is appropriately determined depending on various conditions such as the viscosity of the coating liquid 100 described above, the supply amount, and the adhesive force of the desired adhesive layer. By adjusting the distance in accordance with at least one of the viscosity of the coating liquid 100, the supply amount, and the adhesive force of the adhesive layer, particularly two or three, a more uniform thickness of the coating film 105 can be formed in the leveling step.

As described above, the blade 9 extends in the width direction of the transport belt 21, and is separated from the transport belt 21 by a predetermined distance G when the coating liquid 100 is leveled. As a result, in the leveling step, the coating liquid 100 can be more uniformly leveled over the entire region in the width direction of the transport belt 21. In addition, since the blade 9 is not in contact with the coating surface 210 of the transport belt 21, it is possible to prevent the blade 9 from damaging the transport belt 21.

The blade 9 may be in contact with the transport belt 21 at all times or at an appropriate time when the coating liquid 100 is leveled.

The coating liquid 100 on the coating surface 210 supplied in the supply step is transported to the + side in the y-axis direction by the traveling of the transport belt 21, and is leveled when passing through the gap between the coating surface 210 and the blade 9 by the distance G, and the thickness is made uniform.

The blade 9 may be installed above the transport belt 21 when the leveling step is performed, and may be configured to be detachable from the transport device 2 when the leveling step is not performed.

The length of the blade 9 in the width direction (x-axis direction) of the transport belt 21 is not particularly limited, but is preferably 50 cm or more and 300 cm or less, and more preferably 100 cm or more and 200 cm or less. As a result, the length of the blade 9 in the width direction of the transport belt 21 can be made equal to or longer than the width of the transport belt 21 regardless of the model of the textile printing apparatus 1 or the size of the transport belt 21. Therefore, the blade 9 covers the entire region or the effective region of the transport belt 21 in the width direction, and can level the coating liquid 100.

The leveling of the coating liquid 100 by the blade 9 is performed while driving the transport belt 21 to travel, and the traveling speed of the transport belt 21 when the coating liquid 100 is leveled is substantially the same as the traveling speed of the transport belt 21 when printing is performed. As a result, the traveling speed of the transport belt 21 can be easily controlled.

Here, the “substantially the same” is a concept including a case where the difference between the two traveling speeds is not present, a case where the difference between the two traveling speeds is slightly present, for example, a case where the average of the speed differences is within ±5%.

In the present disclosure, the traveling speed of the transport belt 21 when printing and the traveling speed of the transport belt 21 when leveling the coating liquid 100 may be different. That is, the traveling speed of the transport belt 21 may be appropriately changed when the coating film 105 is formed and when printing is performed.

As illustrated in FIG. 1, the adhesive drying portion 10 is a portion that performs the drying step illustrated in FIG. 3, and is disposed below the transport belt 21.

The adhesive drying portion 10 includes a coil 11 which is a heat source (heater). The coil 11 is made of, for example, a nichrome wire, and is a heating element that generates heat by supplying electric power. The coating film 105 of the coating liquid 100 applied to the coating surface 210 and leveled by the blade 9 can be appropriately dried by the heat emitted by the coil 11.

The disposition position of the adhesive drying portion 10 is not limited to the configuration illustrated in the drawing. In addition, the configuration of the adhesive drying portion 10 is not limited to the configuration illustrated in the drawing.

In addition, in the present embodiment, the configuration in which the coating liquid 100 is applied once to the coating surface 210 of the transport belt 21 is described, but the present disclosure is not limited thereto, and the coating liquid 100 may be applied twice or three times. That is, after the supply step, the leveling step, and the drying step of the coating liquid 100 are performed, these steps may be repeated a plurality of times.

The coating step may be performed by using another device or by coating the coating liquid 100 by a worker using a coating tool or the like. In this case, examples of the coating tools include a brush, an application roller, and the like.

The coating step includes the leveling step of discharging the coating liquid 100 from a nozzle to supply the coating liquid 100 to the coating surface 210, and leveling the supplied coating liquid 100 using the blade 9. As a result, the coating liquid 100 can be stably supplied to the coating surface 210. In addition, the supply of the coating liquid 100 to the coating surface 210 and the leveling of the coating liquid 100 can be continuously performed.

In the present embodiment, the leveling step is described as a configuration in which the leveling step is performed using the blade 9, but the present disclosure is not limited thereto, and the leveling step may be performed by a worker using a tool such as a squeegee. In addition, the leveling step itself may be omitted.

The method of forming an adhesive layer includes a drying step of drying the coating film 105 of the coating liquid 100, which is leveled in the leveling step, by heating. As a result, the coating film 105 can be dried quickly and uniformly, and a homogeneous and good adhesive layer having no unevenness in the adhesive property can be formed at the coating surface 210 of the transport belt 21.

In the present embodiment, the adhesive drying portion 10 that executes the drying step can forcibly or quickly dry the coating film 105, but is not limited thereto, and the adhesive drying portion 10 may be an adhesive drying portion that dries at room temperature, or naturally dries without applying airflow, or the like. In addition, the transport device 2 and the textile printing apparatus 1 may not include the adhesive drying portion 10.

Although the preferred embodiments of the present disclosure are described above, the present disclosure is not limited thereto.

For example, the transport belt and the textile printing apparatus of the present disclosure are not limited to the configurations illustrated above, and each section of the transport belt and the textile printing apparatus can be replaced with any structure that can exhibit the same function. In addition, any structure may be added.

### EXAMPLE

Next, specific examples of the present disclosure will be described.

### 3. Preparation of Water-Based Adhesive Composition for Textile Printing

### Example 1

First, (meth)acrylic resin is synthesized as follows. That is, ion-exchanged water: 114 g is added to a reactor provided with a stirrer, a reflux cooling tube, a thermometer, a nitrogen introduction tube, and a dropping funnel, and the temperature is raised to a predetermined temperature. Thereafter, 498 g of a monomer mixture mixed at a ratio of 36.2% by mass of ethyl methacrylate, 23.2% by mass of butyl methacrylate, 4.5% by mass of butyl acrylate, and 36.1% by mass of 2-ethylhexyl acrylate, 79 g of ion-exchanged water, and 34 g of Emulgen 123P (manufactured by Kao Corporation) as a nonionic surfactant are added to the reactor and mixed and stirred. A predetermined amount of a 2% by mass aqueous solution of ammonium persulfate, which is a persulfate, is added to the homogenized solution, and the solution is heated at a predetermined temperature for a predetermined time. Thereafter, the solution is cooled to room temperature, ion-exchanged water is added, and ammonia water is added and further stirred to synthesize a (meth)acrylic resin.

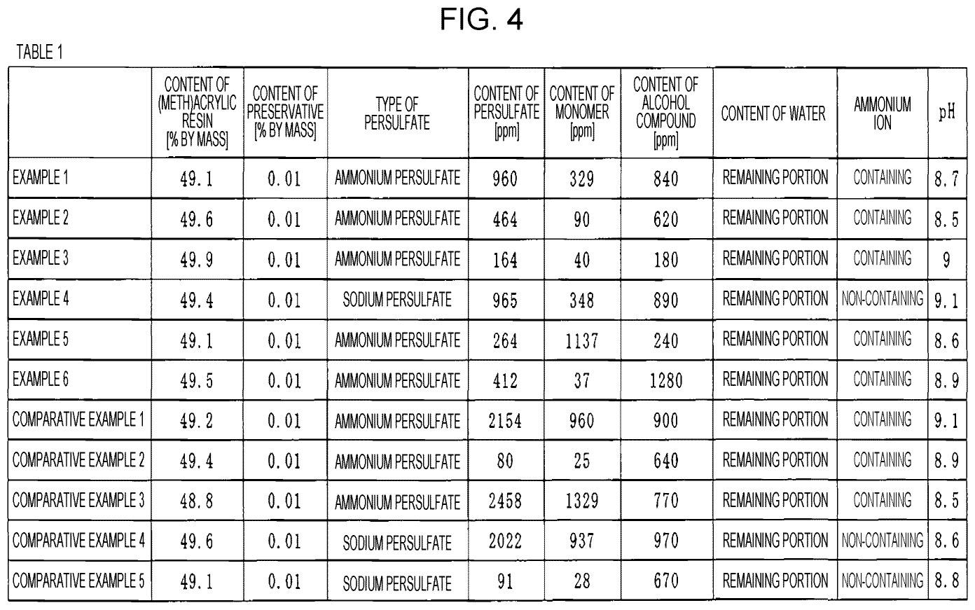

Next, a water-based adhesive composition for textile printing is obtained by mixing each component to have the composition as illustrated in FIG. 4 by using the (meth)acrylic resin synthesized as described above.

### Examples 2 to 6, and Comparative Examples 1 to 5

A water-based adhesive composition for textile printing is prepared in the same manner as in Example 1 except that (meth)acrylic resins synthesized under different conditions are used as the (meth)acrylic resins and the amounts of each component used are changed to obtain the compositions illustrated in FIG. 4. In Examples 4 and Comparative Examples 4 and 5, ammonia water is not used.

The compositions of the water-based adhesive compositions for textile printing of each of the above examples and each of the comparative examples are summarized in FIG. 4. The “content of the persulfate” illustrated in FIG. 4 was obtained as follows. That is, 1 g of the water-based adhesive composition for textile printing of the measurement target and 100 g of a 5% by mass sodium chloride aqueous solution are placed in a beaker, and the mixture is stirred at 500 rpm for 2 hours using a rotor coated with polytetrafluoroethylene. Thereafter, the obtained liquid is filtered, further passes through a GL chromatography disk (aqueous 25A, successor 0.45 μm) manufactured by GL Science, 0.50 g of a potassium iodide aqueous solution of 44% by mass is added to 5.0 g of the liquid, and the mixture is stirred in the dark for 1 hour. The absorbance is measured at a wavelength of 350 nm using a spectrophotometer (manufactured by Hitachi High-Tech, U-3900H type) to perform quantification and obtain the “content of the persulfate”. The “content of the monomer” and “content of the alcohol compound” illustrated in FIG. 4 were obtained as follows. That is, 1 g of the water-based adhesive composition for textile printing of the measurement target, 100 g of a 5% by mass sodium chloride aqueous solution, and 10 g of tetrahydrofuran are placed in a beaker, and the mixture is stirred at 500 rpm for 1 hour using a rotor coated with polytetrafluoroethylene. Thereafter, the obtained liquid was quantified using a gas chromatograph (manufactured by Shimadzu Corporation, GC 2014) using an FID as a detector and a G-300 of the National Institute of Technology and Evaluation as a column, and the “content of the monomer” and the “content of the alcohol compound” were obtained. The pH value illustrated in FIG. 4 is a value measured by immersing a probe in the water-based adhesive composition for textile printing for 3 minutes using a benchtop pH meter (manufactured by HORIBA, Ltd. F72S) at 23° C.

### 4. Formation of Adhesive Layer

The textile printing apparatus illustrated in FIG. 1 is prepared, in an environment of 23° C., the water-based adhesive composition for textile printing is discharged from the coating liquid supply portion onto the endless belt of the digital textile printing machine ML8000 manufactured by Seiko Epson Corporation, leveled with a blade, coated to a thickness of 0.2 mm, and dried under the conditions of humidity of 50%, 23° C., and 8 hours to form an adhesive layer.

### 5. Evaluation

### 5-1. Evaluation of Water-Based Adhesive Composition for Textile Printing

The following evaluations are performed on the water-based adhesive composition for textile printing according to each of the examples and each of the comparative examples.

### 5-1-1. Storage Stability

The water-based adhesive composition for textile printing is placed into a 100 mL polyethylene pouch and heat-sealed, and the state after being left for 7 days in a constant temperature bath at 60° C. is visually observed and evaluated according to the following criteria.
Good: No change is observed in the appearance.
Poor: Aggregation is observed.

### 5-1-2. Odor

Using a portable odor sensor mini XP-329m (manufactured by New Cosmos Electric Co., Ltd.), 0.1 g of a water-based adhesive composition for textile printing is placed into a 250 mL polyethylene container, the container is sealed, and the container is opened after 3 minutes. The container is allowed to stand for 2 minutes, and the average value is obtained and evaluated according to the following criteria. The larger the value, the stronger the odor.
Good: The measured value is less than 900.
Poor: The measured value is 900 or more.

### 5-2. Evaluation of Adhesive Layer

The following evaluations are performed on the adhesive layer according to each of the examples and each of the comparative examples.

### 5-2-1. Durability

The roller-shaped nylon brush in a state of being wet with water is pressed against the adhesive layer provided on the transport belt at 1.0 N/cm in a state of being rotated at a rotation speed of 6 rpm. After 30 days have passed, the rotation of the nylon brush is stopped, and the state of the adhesive layer is visually observed and evaluated according to the following criteria.
Good: No scratch is observed.
Fair: A slight scratch is observed.
Poor: Remarkable irregularities are observed.

### 5-2-2. Water Resistance

The transport belt provided with the adhesive layer is immersed in pure water at 23° C. for 20 minutes, then pulled up from the pure water, and the state of the adhesive layer is visually observed and evaluated according to the following criteria.
Good: No whitening occurs and the adhesive layer is transparent.
Fair: Slight whitening occurs.
Poor: Remarkably whitened.

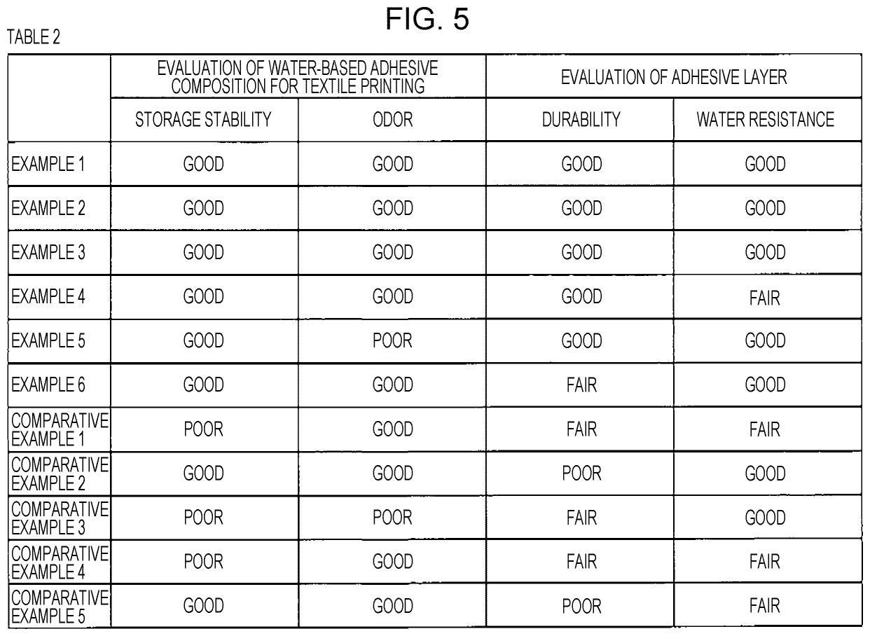

These results are summarized in FIG. 5.

As is clear from FIG. 5, excellent results are obtained in each of the examples. On the other hand, in each of the comparative examples, satisfactory results are not obtained.

What is claimed is:

1. A water-based adhesive composition for textile printing, comprising:
water;
a (meth)acrylic resin; and
a persulfate, wherein
a content of the persulfate is 100 ppm or more and 2000 ppm or less.

2. The water-based adhesive composition for textile printing according to claim 1, further comprising:
a monomer that is the same type as a monomer constituting the (meth)acrylic resin and is in an unpolymerized state at a content of 1000 ppm or less.

3. The water-based adhesive composition for textile printing according to claim 1, wherein
the (meth)acrylic resin contains an ester compound of a (meth)acrylic acid represented by the following Formula (1) as a constituent monomer,
the water-based adhesive composition further comprises
an alcohol compound represented by the following Formula (2) at a content of 1000 ppm or less,
$${R}^{1} - C ( = C {H}_{2} ) - C ( = O ) - O - {R}^{2} \qquad ( 1 )$$
(in Formula (1), R¹ is H or CH₃, and R² is a hydrocarbon group)
$${R}^{2} - OH \qquad ( 2 )$$
(in Formula (2), R² is a hydrocarbon group).

4. The water-based adhesive composition for textile printing according to claim 1, further comprising:
an ammonium ion.

5. The water-based adhesive composition for textile printing according to claim 1, wherein
the persulfate contains an ammonium persulfate.

6. The water-based adhesive composition for textile printing according to claim 1, wherein
a pH of the water-based adhesive composition for textile printing at 23° C. is 7.5 or more and 9.0 or less.

7. A transport belt that transports a fabric to be printed by textile printing, the transport belt comprising:
an adhesive layer that is formed of the water-based adhesive composition for textile printing according to claim 1 on a surface that is in contact with the fabric.

8. A textile printing apparatus comprising:
the transport belt according to claim 7; and
an ink jet head that includes a nozzle discharging ink to the fabric transported by the transport belt.
